(19) United States
(12) Patent Application Publication
(10) Pub. No.: US 2010/0330845 A1
(43) Pub. Date: Dec. 30, 2010

(54) ELELCTRICAL CONNECTOR HAVING BLADE CONTACTS CONTACTING WITH RIB PORTIONS PROJECTING FROM BOTTOM SURFACE OF HOUSING

(75) Inventor: DE-JIN CHEN, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/697,209

(22) Filed: Jan. 30, 2010

(30) Foreign Application Priority Data
Jun. 24, 2009 (CN) 200920304923.0

(51) Int. Cl. H01R 24/00

(52) U.S. Cl. 439/660

(57) ABSTRACT

An electrical connector includes a base housing and a plurality of blade contacts. The housing includes a base wall, a back wall and a pair of opposing side walls protruding from three edges of the base wall and commonly defining a concave part. Each of the blade contacts includes a fixing portion embedded in the back wall and a contacting portion seated in the concave part. The base wall defines a plurality of rib portions projecting form a bottom surface of the concave part and bottom edges of the contacting portions of the plurality of contacts being in contact with the rib portions.

### BACKGROUND OF THE INVENTION

1. Field of the Invention

The present invention relates to an electrical connector. More particularly, the present invention relates to a blade contact which is pressed into a base housing and, for example, is solder bonded to a printed circuit board.

2. Description of the Related Art

U.S. Pat. No. 7,112,102 issued to J. S. T Masaki et al. on Sep. 26, 2006 disclose a conventional electrical connector which is assembled on a printed circuit board disposed within an electronic device, such as an infinitesimal, so-called chip-sized package-type, to feed power supply from a battery to the electronic device. The connector has a bottom wall and three side walls perpendicular to the bottom wall and commonly forming a forward and upward opening concave part. Three blade contacts are retained in the back wall and the bottom edges of the contacting part are in contact with the bottom face of the concave part. The bottom wall of the connector will withstand external force from the contacts in response to a downward force on the contacts from insertion of a counter connector, which will result in a breakage of the thin bottom wall.

In view of the above, a novel electrical connector that overcomes the above-mentioned disadvantages is desired.

### SUMMARY OF THE INVENTION

Accordingly, an object of the present invention is to provide an electrical connector with a better rigidity.

To fulfill the above-mentioned object, an electrical connector comprises a base housing and a plurality of blade contacts. The housing comprises a base wall, a back wall and a pair of opposing side walls protruding from three edges of the base wall and commonly defining a concave part. Each of the blade contacts includes a fixing portion embedded in the back wall and a contacting portion seated in the concave part. The base wall defines a plurality of rib portions projecting form a bottom surface of the concave part and bottom edges of the contacting portions of the plurality of contacts being in contact with the rib portions.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector according to the present invention;

FIG. 2 is an exploded perspective view of the electrical connector of FIG. 1;

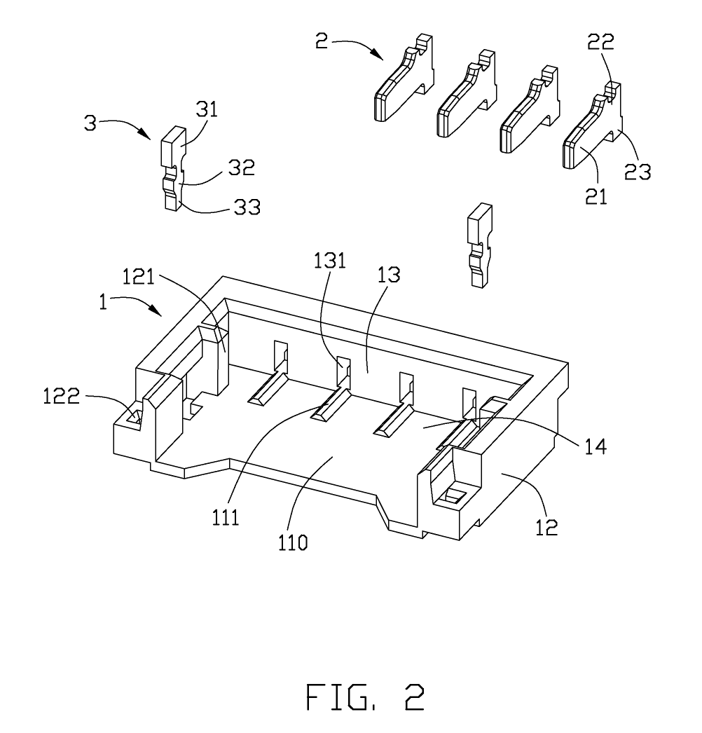

FIG. 3 is an exploded perspective view of the electrical from another view; and

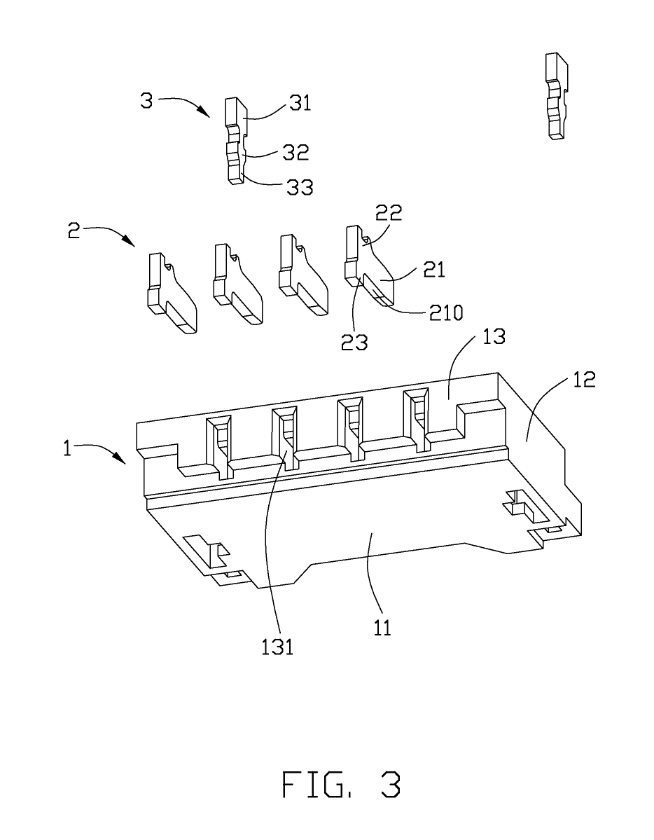

FIG. 4 is a cross-section view of the electrical connector taken along line 4-4 shown in FIG. 1.

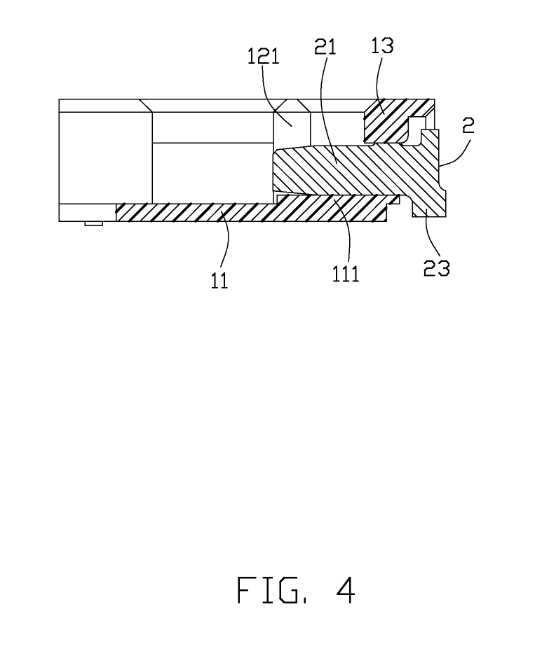

### DETAILED DESCRIPTION OF THE PREFERRED EMBODIMENT OF THE INVENTION

Reference will now be made to the drawings to describe the present invention in detail.

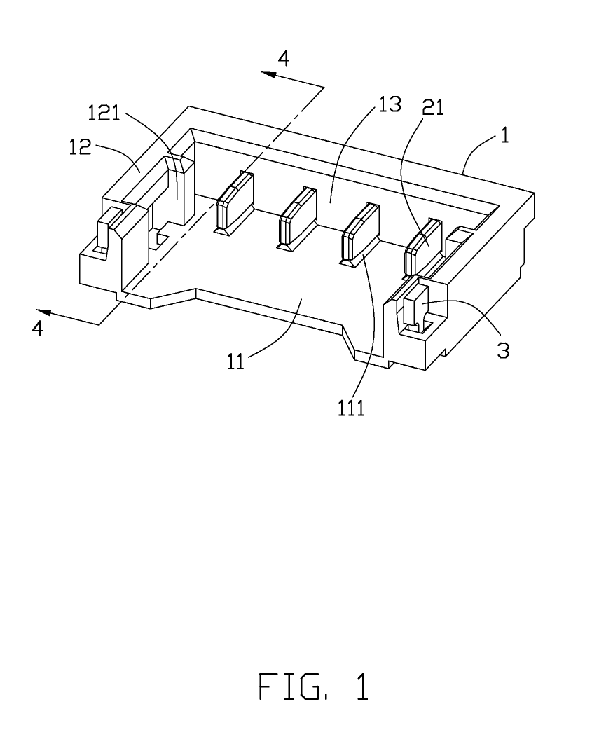

Referring to FIGS. 1˜4, an electrical connector according to one embodiment of this present invention is of a substantially rectangular and fixed to a printed circuit board (not shown) by solder bonding. The electrical connector has a substantially rectangular base housing 1 of insulating material in which two sides are open and a plurality of elongated plate blade contacts 2, for example four contacts in this embodiment. The base housing 1 has a base wall 11. A pair of parallel opposing side walls 12 erect from two sides of the base wall 11, and a back wall 13 is connecting with said two side walls 12. These walls 11, 12, 13 commonly form a concave part or receiving cavity 14. The base wall 11 has an inner surface 110, i.e. the bottom surface of the concave part 14 and a mounting face opposite to the inner surface 110 and confronting with the printed circuit board. The base housing 1 opens in two sides, that is, a face opposing the base wall 11 and a face opposing to the back wall 13 are opening.

The base housing 1 further defines a pair of beam portions 121 projecting into the concave part 14 from the inner surface of the side walls 12 respectively with a predetermined distance, which two are opposite to each other and arranged for preventing from mis-mating when the connector is inserted by a counterpart connector (not shown). The beam portions 121 intersect the inner surface 110 of the base wall 11 and a hole 122 is defined running through an upper face and bottom face of each side wall 12. The hole 122 is located at a front end of the side wall to receive a retaining ear 3 to attach the connector on the printed circuit board. The retaining ears 3 is made of metal plate and includes a top stopping portion 31 abutting against a top face of the hole 122, a leg portion 33 extending out of the mounting face of the base housing 1 and a retaining portion 32 jointing the stopping portion and the leg portion. The retaining portion 32 has barbs (not labeled) at two lateral sides thereof interfering with the inner surfaces of the hole.

The base housing 1 defines four fixing holes 131 at the back wall 13, which run through the back wall 13 in a first direction parallel to the side walls 12. Four planar blade contacts 2 are arranged at the back wall 13 of the concave part 11, in parallel with the pair of opposing side walls 12. The blade contact 3 is held by the base wall 11 in a state that it is inserted and engaged to fixing holes 131. The inner surface 110 of the base wall 11 has upwardly projecting rib portions 111, and the rib portions 111 extend in the first direction and are aligned with the fixing holes 131.

The blade contact 3 includes a rectangular board-shaped contacting portion 21 for connecting to contact of the counter connector and a fixing portion 32 which is provided at the back end of the contacting portion 21 and is inserted and engaged within the back wall 13. A bottom edge 210 of the contacting portion 21 extends in the longitudinal direction of the contacting portion 31 is in contact with the projecting portion 110 of the base wall 11. The rib portions 111 thicken the bottom wall 11 at the stress point thereof so that the rigidity of the base wall is increased compared to the case of not-thicken base wall. The fixing part 32 extends a lead portion 23, which is solder bonded to the printed circuit board.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an base housing comprising a base wall, a back wall and a pair of opposing side walls, the back wall and the pair of opposing side walls protruding from three edges of the base wall and commonly defining a concave part therealong; and
a plurality of blade contacts of an elongated plate, each of the blade contacts comprising a fixing portion embedded in the back wall and a contacting portion seated in the concave part;
wherein the base wall defines a plurality of rib portions projecting form a bottom surface of the concave part and bottom edges of the contacting portions of the plurality of contacts being in contact with the rib portions.

2. The electrical connector as claimed in claim 1, wherein the fixing portion extends a solder portion therefrom.

3. The electrical connector as claimed in claim 2, wherein the contacting portion of the contacts are parallel to the side wall.

4. The electrical connector as claimed in claim 3, wherein the back wall defines fixing holes to receive the fixing portions and each rib portion extends parallel to the side wall and aligned with corresponding hole.

5. An electrical connector comprising:
an insulative housing including a rear wall, a bottom wall and a pair of side walls commonly defining a receiving cavity for receiving a complementary connector; and
a plurality of contacts each having a retention section retained into the rear wall, a blade type contacting section extending forwardly into the receiving cavity and a tail sections exposed rearwardly outside of the rear wall; wherein
the contacting section is essentially spaced from a main upward surface of the bottom wall with a gap while main upward surface is equipped with a plurality of ribs in vertical alignment with the corresponding contacting sections, respectively, to fill said gap and supporting a bottom edge of the contacting section.

6. The electrical connector as claimed in claim 5, wherein each of said ribs defines a wedged structure on each side thereof in an elevation view taken from a front-to-back direction along which the complementary connector is inserted into the receiving cavity.

7. The electrical connector as claimed in claim 5, wherein said retention section of each of said contacts defines a barb structure on an upper edge of the retention section.

8. The electrical connector as claimed in claim 7, wherein a bottom edge of the retention section is not equipped with any barbs.

9. The electrical connector as claimed in claim 5, wherein the rear wall defines a plurality of through holes to not only receive the retention section of the corresponding contact but also allow the corresponding contacting section to pass during forwardly assembling the contact to the housing under condition that a bottom side of each of the through holes is located above the main upward surface of the bottom wall while being flush with an upper ledge of the corresponding rib; wherein
the rib, in a top view, is aligned with said through hole in a front-to-back direction while, in elevation view taken from said front-to-back direction, being downwardly offset from said through hole.

10. An electrical connector comprising:
an insulative housing defining a horizontal bottom wall and a vertical rear wall perpendicular to each other and commonly defining a receiving cavity therebetween;
a plurality of through holes defining the rear wall;
a plurality of contacts each forwardly extending through the through hole from a rear face of the rear wall under condition that each of said contacts includes a contacting section exposed in the receiving cavity and a tail section rearwardly exposed outside of the rear wall; and
a plurality of ribs formed on a top face of the bottom wall in alignment with the corresponding through holes in a front-to-back direction, respectively; wherein
said contacting section is of a blade type with thereof a bottom edge seated upon a ridge of the corresponding rib.

11. The electrical connector as claimed in claim 10, wherein said ridge is essentially flush a bottom face of the corresponding through hole.

12. The electrical connector as claimed in claim 10, wherein said contact includes a retention section received in the corresponding through hole under condition that the retention section is of a blade type with opposite upper and bottom edges thereof and only the upper edge is equipped with a barb structure while the bottom edge does not.
